(19) United States
(12) Patent Application Publication
(10) Pub. No.: US 2008/0144432 A1
(43) Pub. Date: Jun. 19, 2008

(54) MIXFIX: fine-tuned graded mixing/entropic alphabet for chemical and visual encoding, efficient processing, and decorative painting

(76) Inventor: Gideon Samid, Rockville, MD (US)

Correspondence Address: Gideon Samid, 13 Tapiola Ct., Rockville, MD, 20850, US

(21) Appl. No.: 11/902,055

(22) Filed: Sep. 18, 2007

Related U.S. Application Data
(60) Provisional application No. 60/845,164, filed on Sep. 18, 2006.
(60) Provisional application No. 60/907,869, filed on Apr. 19, 2007.
(60) Provisional application No. 60/861,037, filed on Nov. 27, 2006.
(60) Provisional application No. 60/874,957, filed on Dec. 15, 2006.

(51) Int. Cl. B01F 5/00; G06K 19/06

(52) U.S. Cl. 366/348; 235/494

(57) ABSTRACT

MIXFIX is an mixing apparatus featuring fine tuned mixing applicable as efficient and inexpensive in-line process mixing that also doubles as a regulatory valve. The controlled mixing degree allows for creating an alphabet where the degree of mixing (entropy) indicates different letters so that a computer controlled MIXFIX will generate any desired message that can be painted on surfaces and be readily interpreted by computers fed by regular digital cameras. Such entropic alphabet is read more reliably than normal English letters and even more reliably than bar codes, creating an opportunity for efficient labeling of anything that can then be camera captured and computer recognized including traffic control, industrial control, retail aid (replacing RFID), and military applications (preventing friendly fire).

### CROSS-REFERENCE TO RELATED APPLICATIONS

This application claims as priority date provisional application filed by the same inventor: 113268 U.S. PTO 60/845,164 (091806) On Sep. 18, 2006 entitled “Innovation Package G6918”. It also claims a priority data provisional application filed by the same inventor 112956 U.S. PTO 60/907,869, (041907), entitled “Innovation Package g7419”, It also claims as priority data provisional application 60/861,037 filed by the same inventor on Nov. 27, 2006 entitled “Innovation Package G6n27” and also claims as priority date provisional application filed by the same inventor U.S. PTO 60/874,957 entitled “Innovation Package G6d15”; and is also based on utility patent application 11790876 entitled “BiPSA: An Inferential Methodology and a Computational Tool”

### BRIEF SUMMARY OF THE INVENTION

Mixing is normally done through a fast rotating blade. This method leaves some material unmixed, and the rest with varying consistency, and it suffers from inability to control the degree of mixing. This invention is based on a mechanism that switches the flow pattern of a fluid as often as desired, with every switch impacting the flow lines resulting in a mixed outcome. By carefully controlling the change of the flow lines one achieves quick mixing, highly consistent and predicable mixing, mixing in-line (not in a special vessel), and mixing to a desired grade. The latter would allow two or more components to be mixed to a desired degree where such a mixture may have numerous advantages in various applications. In particular one could mix two incompatible colors at various degrees of mixing and spray the mixture on a surface such that the degree of mixing will carry information, allowing one to write messages that are computer friendly and readable via any of the many cameras around. The mixing is effected through a contraption that is built in to a pipeline where the two components of the eventual mixture are flowing. The cross section of the pipeline is fitted with two perforated discs: one stationary, and one rotating. As the rotating disc moves over the stationary one different locations experience a congruence of the holes from both discs, and only such holes allow for the fluids to flow through them. As the rotating disc rotates around, new areas permit flow and previous flow lines are abruptly curtailed, this creates eddies and turbulence at both ends of the two adjacent discs. The size of the holes, the pace of switching the flow zones will determine the degree of mixing. By controlling the rotating disc via a built in computer it is possible to fine tune the degree of mixing and create on the output a partial mixing of the components. Such partial mixing may be encoded to deliver a message when sprayed somewhere, and it may be applied to two or more paints that generates a random looking mixture of controlled degree. The MIXFIX is designed for use in nominal chemical processing since it may be combined with a valve operation. The two discs may be placed at a resting point either in such a configuration that there is zero flow (no holes congruence between the two discs), or placed at maximum fixed flow (maximum congruence between the discs). Because all the flow must go through the mixing holes, this apparatus does not allow for a laminar layer that is not reached by a blade; 100% of the flow undergoes mixing. The encoding application allows for creation of an entropic alphabet where the letters are marked by the degree of mixing of two or more colors.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable

### BACKGROUND OF THE INVENTION

Mixing is a fundamental unit operation in chemical engineering and apart from varying the shape of the mixing blades it has escaped major innovation impact, so it was ripe for a proactive innovative thinking.

### DETAILED DESCRIPTION OF THE INVENTION

### Switched-Gates Mix-Valve

### In-Line Highly Regulated Mixing and Valve Operation

Abstract: A highly-regulated (temporal and spatial) unified mixer and valve for in-line operation, fit for thick and viscous fluids as well as for thin and low-viscosity liquids or gases. Mixing level is precisely controlled over time, and degree, may be implemented as very large, or as very small construction; may be used to insure level of mixing, effect mixing variance, with various applications, including creating material and electrical gradients, as well as encoding and data-stamping, aging and movement monitoring, and time-lapse. In combination of an appropriate separator, Mix-Valve can be involved in chemical-based computing applications.

The Mix-Valve Solves the intrinsic problem of blade-mixers which tend to leave unmixed zones (static or dynamic). It allows for on/off valves or regulatory ones. In the latter case the Mix-Valve appears superior to the common needle valve which tends to clog, and require frequent maintenance.

### 1. INTRODUCTION

Mixing is a basic unit operation in chemical engineering. It is a common and essential step in most reactors; it is an essential final step in many products which require strict uniformity, and exact proportions of ingredients. In these applications mixing is an extreme action where one attempts to ‘mix as much as possible’ the two or more mixing components. However, other applications require different degrees of mixing, and in these cases it is necessary to be able to control the degree of mixing, and to deliver the exact measure, with the required variance as the application requires.

The common technical solutions for mixing are a rotating blade, bubbling fluids, and fluidized beds. Neither of these solutions is especially conducive for a controlled mixing degree, and neither one is especially fit for quick temporal response. Also, while a rotating blade (by far the most common mixing solution) is widely applicable, the other two are restricted to special situations.

Mixing being so fundamental it has become a topic for research using the Innovation Turing Machine procedure. Its main logic would be laid out below, as well as some important applications for the mixing process, a definition of mixing, and some words on measuring mixing degree.

1.1. Mixing: A Theoretical View

Mixing of two or more substances is a process where the mixed elements lose their bulk or homogenous zones in favor of a uniform space where even small sections thereto hold a uniform proportion of the ingredients. The size of these sections signifies the extent, or the degree of the mixing.

1.1.1. Complete Mixing

If a component x of quantity X is mixed with a component y of quantity Y, within some reference space, then a complete mix will be a situation where for an arbitrary volume V in the reference space there will hold, either:

i. Xv→0; and Yv→0 or:
ii. Xv/Yv→X/Y
where Xv and Yv are the quantities of x and y in volume V.

If the above holds throughout the reference space for all V≧δ, where δ is the smallest volume where it is possible to have: Xv=(X/Y)Yv≠0, then the mixture is regarded as complete, or “perfect”.

This definition can readily be extended to an arbitrary number of mixed components.

1.1.2. Partial, or Degreed Mixing

There are many ways to define partial, or degreed mixing. One would eventually pick the most advantageous. Here below is one such definition. We focus on a portion U of the reference space, such that condition (i.) of the complete mixing is not observed anywhere in it. In other words, U is the portion of space where at least one of the two components (x,y) is present. We divide U to t units of δ size each. The division may call for the δ-size volumes to be mutually exclusive (every point in U is part of one, and only one δ-size volume), or otherwise (as long as it is well defined). Let m be the number of 6 volumes where condition (ii) of the complete mixing is satisfied, then M=m/t will be regarded as the mixing degree with respect to U, and the U partition into t volumes of size δ. Clearly: 0≦M≦1.0. One could use the same definition with respect to a different size volume v>δ. In such a case one may want to use tolerance measure Δ<1.0, and count the number of v size volumes, m, where:

(1−Δ)(X/Y)≦Xv/Yv≦(1+Δ)(X/Y)

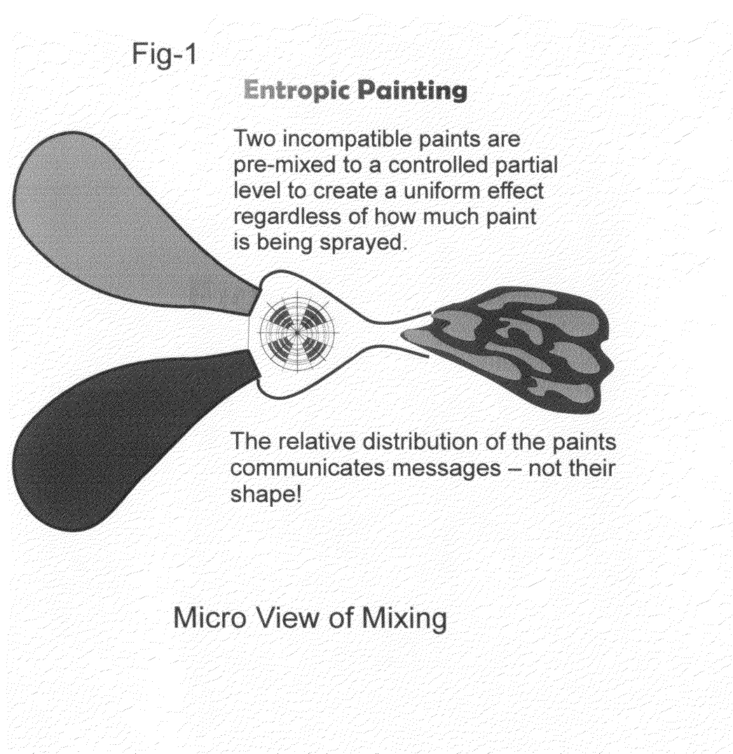

and then define the mixing degree M(v, Δ)=m/t. See FIG. 1 “Micro View of Mixing”

1.1.3. Mixing as Momentum Variance

To increase the degree of mixing of a mixture one would need to impart different momentum “kicks” to adjacent elements of the uniformly moving array of single component flow. Such kicks can be done deterministically, by targeting each element in particular, and thus engineering the intermix. This is a realistic option for mixing discrete bodies, like pieces in a checker game.

Alternatively, one would strive for a sweeping delivery of momentum such that adjacent elements of any given mixed-in component would ‘feel’ a different momentum kick that would break down their uniform (laminar) flow.

Rotating blades are designed to differentiate between adjacent fluid elements by creating a varied momentum perpendicular to the plane of major blade rotation. The perpendicular momentum depends on the distance of fluid element from the rotational axis.

In a bubbling fluid, or a fluidized bed, the varied impact is provided by a randomization process which is generally less efficient than a blade.

The mix-valve offers a different method to impart varying degrees of momentum to adjacent volumes of fluids.

1.1.3.1. The Mix-Valve Mixing Method

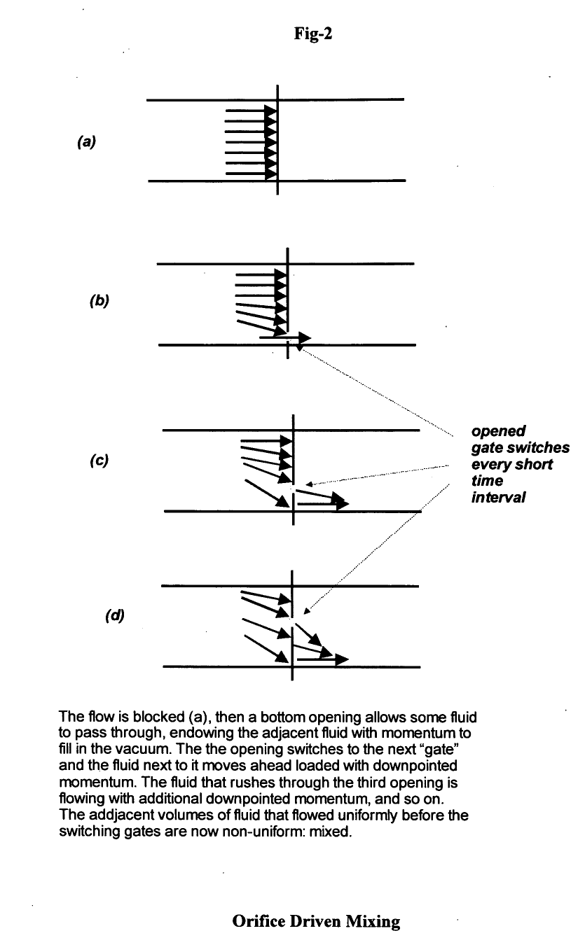

The underlying idea: a blocked flow that is opened at a given spot to generate a flow-through, and a rush of the adjacent volumes of fluid to fill the vacuum. In the next time interval, the first opened spot is closed, and an near-by spot is being opened. Now the fluid elements that received a momentum jolt perpendicular to the direction of flow (by the virtue of the vacuum generated by the fluid that escaped through the first opening), are now feeling an opening at their spot. This opening generates a flow in the direction of the pipe, combined with the momentum acquired in rushing to fill in the former fluid element. That fluid is rushing through that new opening with a velocity component that points askew of the former element that passed through the first opening. This accomplishes the goal of imparting varying momentum vector to adjacent fluid elements. The process repeats: the second opening closes after a short (and controlled) interval of time ΔT, and a near by opening is opened up. Through this third opening the fluid the emerges, possesses a different momentum vector (relative to the fluid that emerged from the second opening). This continues until one reaches the other end of the flow width. At that point the process repeats. The first opening opens up, then the second, and so forth. By repeating this process as the flow is driving fluid through the “switched-gates” the momentum variance is continually achieved, effecting a continual mix of the incoming fluid components. See FIG. 2 “Orifice Driven Mixing”

1.1.4. Unmixing

A mixture can be unmixed by selectively attaching uniform momentum vectors to different elements of the mixture. These vectors would increase the concentration of each mixture component in their direction. To unmix it is necessary to find a way to discriminate among the mixed components. Two common ways are:
artificial gravity
electric charge

In the first case a centrifuge will be used, and in the second, an electromagnet, or an electric charge.

1.2. Mixing Applications

We divide mixing applications to degreed vs. extreme mixings, and to unitary mixing.

1.2.1. Extreme Mixings

These are applications where one attempts to achieve maximum mixing between the mixed ingredients. Such are applications where the mixture leads to a chemical reaction or heat exchange, or applications where the mixture is the final product and it must be as homogenous and as component unified as possible.

1.2.2. Degreed Mixing

Mixing to a specific (not extreme) degree is applicable for kinetic control of reaction, for a controlled material strength, for aging metrics, for motion detection, and for encoding.

1.2.2.1. Encoding

If a mixture can be reliably read as to its degree of mixing then that degree can be used to encode information, provided the mixture is of such high viscosity that the mixing degree is fixed, and subject to one's ability to achieve the desired degree of mixing with sufficient accuracy.

If one could achieve d separate degrees of mixing in a mixture of size s, and read them with sufficient accuracy then, d*k numbers can be encoded in a mixture comprised of k unordered mixture elements of size s each. If the k mixture elements are order-fixed then the data capacity of this configuration rises to be d^{k}.

Encoding can be used to stamp manufacturing data on a piece of plastic or any highly viscous product; it can be used to achieve a permanent record unaffected by electromagnetic pulses.

1.2.2.1.1. Subliminal Messages

Using a mixture-degree as a basis for data encoding would allow one to implant a subliminal message in such a data set. This is because a given mixture is read as a given data element based on the extent to which the two or more ingredients are intermixed. Albeit, there are numerous layouts of the two or more mixed-in ingredients which would qualify as the same mixing degree, each of those layouts could signify a different submessage, which will require a reader who could interpret that subliminal code. The reader who only checks out the mixing degree will be oblivious to that subliminal messaging.

A simpler way for submessaging would be based on the measured size of the mixture. A given area A could be read as a whole and be judged to be at mixing degree Ma. However elements of A, say of size 0.1A could have M1+m1, M1+m2, M1−m3, . . . small variations from M1 such that these variations would be cancelled out when analyzing the degree of mixing in area A, but by analyzing the 1/10 size portion of A, a reader would capture m1, m2, m3 and get read that subliminal message.

1.2.2.2. Aging Metrics

A liquid comprised of two or more partially mixed components will overtime either become more mixed, or less so. If there are no separation forces, then the natural movement of the material components would create natural mixing (increased entropy). The extent of the increase in mixing degree is a function of time. Hence by creating a partial (degreed) mixing, it is possible to ascertain the age of a mixture by reading its present mixing degree.

1.2.2.3. Motion Detection

If a liquid mixture is subject to vibration and rotation, then its natural mixing degree would increase. Hence by creating a partial (degreed) mixture, and then reading the mixture degree after some handling of the specimen, it would be possible to ascertain the extent of vibration and rotation sustained by that sample. The more movement, the greater the degree of mixture.

1.2.2.4. Clock

In the absence of discriminating forces the various components of a highly fluid mixture will get more intermixed with time. This is the molecular interpretation of the second law of thermodynamics: the universal increase of entropy. Hence, by reading the degree of mixture as M1 at time point 1, and as M2>M1 at a later point of time 2, one could deduce the time lapse T2−T1.

In order to increase the accuracy of such reading one would opt to achieve the gap M2−M1 in a mixing zone where the reading is most accurate. One would then use the ability to achieve a preset degree of mixing to start the clock on the desired M1 mixing state.

1.2.2.5. Trigger

Today most trigger mechanisms are based on electronic circuitry, and/or delicate mechanisms. Such circuits can be overwhelmed with an electromagnetic shock. A degreed-mixture clock will not be affected by such a shock, and thus one could design a trigger based on time lapsed, sustained vibration, etc.

1.2.3. Unitary Mixing

When a fluid ingredient is mixed within itself it is called unitary mixing. Such mixing may have as its aim a uniform property, like temperature, or the creation of turbulence and eddies for various purposes.

In particular one could aim to reduce sedimentation on pipe walls by effecting a turbulent flow in the pipeline. The pipes may be large industrial settings, or minute contraption, possibly even blood vessels. The smaller the cross-section of the flow, the greater the advantage of an in-line mixing solution like mix-valve, compared to a standard rotating blade solution.

1.3. Reading Mixture Degrees

To determine the degree of mixing in a mixture one would have the theoretical option to account for the spatial position of every infinitely small element of every mixed element, and compute from this data the mixing degree as defined above.

Practically though, it is necessary to resort to statistical sampling and deduce from the measurement of the sample about the mixture as a whole.

Depending on the reading method the sampling may be three dimensional, or two dimensional (a superficial cut).

1.3.1. 3D Reading

3D reading requires some mechanism to penetrate the bulk of the mixture to effect the reading. Such penetration can be achieved via an electromagnetic field that would be affected according to the concentration of one or more mixed-in ingredients. The impact of the concentration extent would be identified on the outgoing electromagnetic wave. Sound waves are another possibility.

The sampling in such case would be the slice of the mixture through which the waves move about.

1.3.2. 2D Reading

In this case, either the external surface of the mixture is subject to the reading action, or the mixture is sliced up, and an inner surface becomes the object for the reading action. Superficial reading may be effected even through the naked eye, if one or more of the ingredients have a distinct color. Of course the resolution one could hope for in a naked eye reading of mixture degree is very poor, only binary perhaps (mixed, not-mixed). Alternatively one would could take pictures based on any range of the electromagnetic spectrum, and then analyze the pixilated picture using appropriate algorithms.

### 2. PRINCIPLE OF OPERATION

Mixing is achieved by forcing fluid through a timed sequence of geometrically varying flow openings. When a fixed barrier that prevents flow is suddenly removed, and exposes a lower pressure zone beyond it, then the higher pressure side experiences a flow through the opening generated by the removed barrier. Neighboring zones acquire momentum aimed towards the new opening. If after a short period of time Δt that barrier comes back, and right then or shortly afterwards a different section of the flow barrier is removed, then the fluid switches to flow through the new opening. Fluid in the zones neighboring the new opening acquire momentum in the direction of that opening. And hence any fluid zone that neighbors both openings would sustain a momentum acquisition in one direction, followed by momentum acquisition in another, which is the very action of mixing. Next, the second opening closes back, and a third opening opens up. This sequence of opening to be called gate-switching creates a net flow from the high pressure zone to the low pressure zone at the other side of the barrier. The crossing fluid is driven by momentum vectors with strong and varying components perpendicular to the direction of flow. These momentum vectors effect the operation of mixing.

We shall define the mixing analysis setting, and offer a rigorous definition of the mix-valve operation. This abstract definition would then be reduced to specific implementations. The mixing action here described could be part of a larger complex setting as described below.

2.1. The Mixing Analysis Setting

We envision a mixture of fluid components: c₁, c₂, c₃, . . . cₙ at a mixing degree M1, defined as specified above, or through any qualified definition of mixture extent or degree. The mixture is contained in a so called premix container, since M1 will be referred to as the premix mixture degree. The quantity of mixture in the premix container is Q, measured by volume or mass as appropriate.

We shall build a mixing apparatus that would transport the fluid Q into another container, called the postmix container, where the fluid would be in an increased state of mixing M2.

To effect that transport we would build a pressure gradient between the premix and the postmix container. The pressure gradient would be effected through a flow conduit, to be called a pipe.

The pipe would be fixed with the built-in mix-valve contraption.

The mix-valve contraption would be comprised of a flow barrier that may be partially opened in a dynamic fashion described herein:

The barrier will have a complete closed position, or state. In that state the barrier stops all the flow from the premix container to the postmix container. The barrier should be strong enough to sustain the pressure gradient between the premix side of the pipe and the postmix side of the pipe. The barrier has the same cross-section as the pipe.

At point of time t0 a hole h1 is opened up within the barrier surface. h1 has a definite, well defined shape, and a definite, well defined position within the barrier cross-section. As h1 changes its position from closed to open, the fluid starts flowing from the premix side to the postmix side. At time point t1, h1 is closed. One assumes that the time needed for opening and for closing the hole is small compared to t1. Also at t1 another hole, h2, with a different or similar shape positioned differently than h1 on the surface of the barrier is opened up to allow fluid flow through it. h2 closes at time point t2, and at that time a different hole h3 opens up and remains open until time point t3. This sequence of one hole closes while another opens repeats itself until the entire quantity Q of fluid passes through from the premix container to the postmix container.

The sequence that starts at time point t0, and is defined by (h1,t1), (h2,t2), (h3,t3), . . . is called the mixing sequence, MS.

One may note that the time intervals (t0-t1), (t1-t2), (t2-t3), (t3-t4), . . . etc may be equal or different, and that the holes may be repetitive so that hi=hj for any i, j=1, 2, 3 . . . k such that |i−j|<>1. In other words two successive holes can not be the same, but otherwise then can be repetitive. In fact the MS can be comprised of a periodic sequence.

It is important to note that a given hole hi may be part of another hole h2. In that case when h1 closes, and h2 opens up it look as if h1 did not close because the same area continues to be open, now as part of the next hole, h2.

We can write:

M2=f(M1,MS,Q,T)

where T is the time that was required for the quantity of mixture Q to be transported from the premix container to the postmix container. The mixture quantity Q will be interpreted to represent the complete set of attributes of that fluid: the mixed in components, their temperatures, etc.

The main claim is that this mixing apparatus has several advantages over its alternatives.

2.2. Settings with a Mix-Valve Component

One such setting is suggested by the name: a combined mixture and valve operation. Another is a succession of mixing and separation.

2.2.1. Mix-Valve Assembly

The mix-valve assembly can be used in many instances where only a valve is required. By creating a durable stable open state, the fluid flows through, without special mixing action, and when that opening is closed, the fluid flow stops. Each such valve may be designed for a default open or a default closed position.

2.2.2. Mixing Separation Combination

Based on the choice of mixed-in components there might be several ways to effect the opposite action: separation. This may be done by gravitation (centrifuge) where appropriate or by electro, or electromagnetic means.

By connecting a mix-valve with a separator one opens up various possibilities for useful combination. Two main categories:
1. reaction or operation transport
2. computational purpose

2.2.2.1. Reaction or Operation Transport

There are cyclical situations where a substrate undergoes some “loading” at one end, followed by a “discharging” on the other end. Such a substrate could be loaded in its separation state, and discharged in its mixed state, and so operate cyclically.

Since the mix-valve solution may operate on small size flows, this may serve as a solution for small systems, like in medical applications.

2.2.2.2. Computational Purpose

One could contrive an apparatus where a fluid undergoes a succession of mixing and separation, with each state is followed by a mix-state reading device. The accuracy of the read out would allow for such a setting to emulate an existing differential question of interest, and the readout would constitute a solution thereto.

### 3. IMPLEMENTATIONS

We classify implementations according to:
size
purpose
gate switching level
viscosity
configuration

3.1. Size Based Classification

### Categories:

nominal implementations
mini implementations
micro implementations
nano implementations

A nominal implementation is a typical industrial pipeline, where a rotating blade mixer is replaced by a Mix-Valve. For small tubes, this would a mini implementation, and for micro-size the action would be even on a smaller scale. The extreme small size is ‘nano’ where carbon tubes and alike could be the switching gates.

3.2. Purpose Based Classification

Mix-Valve may be used for ordinary mixing purposes, where the objective is to achieve the highest degree of mixing. It may also be used for degreed mixing as required for encoding purposes, and for situations where the degreed mixing is to achieve a special process dynamics. It may also be used for virtual mixing (creating turbulence) for purposes like preventing sedimentation in the flow line and to enhance heat transfer. Some special purposes are discussed below:
encoding plastic and high-viscosity products
enhancing blood flow

3.2.1. Enhancing Blood Flow

Stationary blood layers clinging to arteries and veins may enhance harmful sedimentation and clogging. Such can be counteracted by enhanced turbulence. The Switched-Gates Mix-valve solution may be used to enhance flow turbulence.

Major blood vessel may be fitted with a patient's own tissue growth that features two or more openings which are opened and closed by pulsating contraction. If the size of each opening is similar to the size of the blood vessel it is fitted to, then there would be no measurable increase in flow resistance, only a net gain in turbulence.

3.2.2. Encoding Plastic and High-Viscosity Products

The Switched gates Mix-Valve can be activated and deactivated at will and at very high time resolution. This may be used to encode any high viscosity product flowing through a conduit fitted with the Mix-valve. For a given stretch dx1 the mixture will be at degree M1, and for the next stretch, dx2, the mixture will be at degree M2, and so on. The result would be a product that its longitude axis would be marked with M1, M2, M3 . . . encoded mixtures. The reading of the mixture can be done visually or though any sensor that would distinguish between the mixed-in ingredients. The high viscosity of the product would insure that the mixture degree would not change with time.

Such encoding could be used to stamp manufacturing data onto appropriate products to assist in forensic and terror fighting investigations.

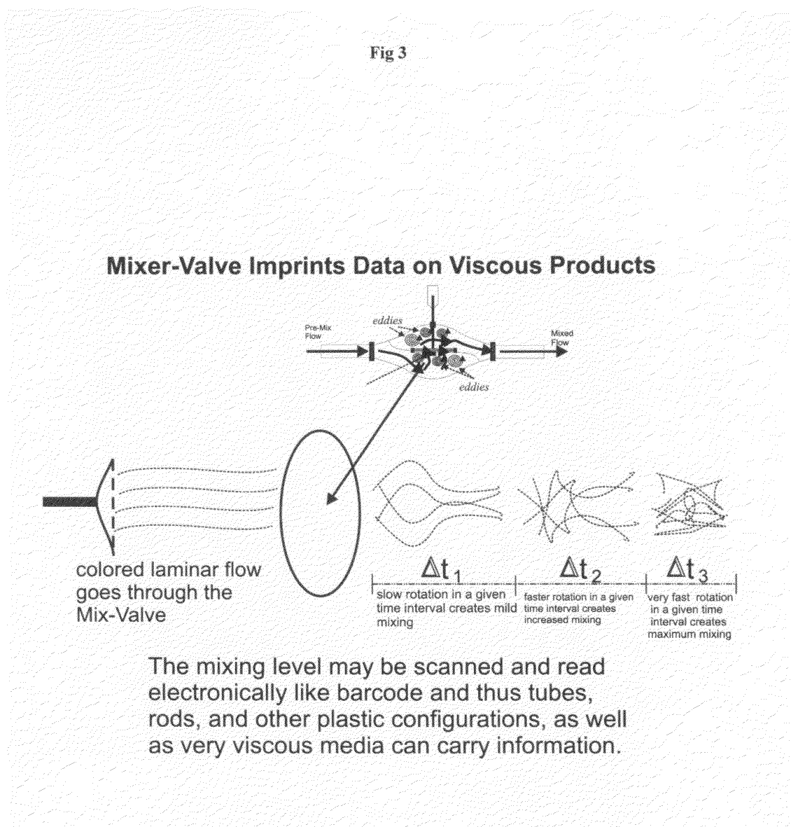

It could also be used in a combat environment when it is necessary to identify vehicles, equipment and people, and where electronic identification suffers from some serious shortcomings. See FIG. 3: “Mixer Valve Imprints Data on Viscous Products”

3.2.2.1. Combat Vehicle, Equipment, and People Identification

In battle vehicles may be covered with visible plastic sheets encoded with sequenced areas of degreed mixing where the mixed-substrate is selected to enhance distance readability through a variety of sensors.

The sensors may be simple binocular, or digital readout telescopic lenses, or they may be IR readouts, where the mixed-in material is distinguished from the other by heat reflection, and/or conductivity. The mixed in material may be ferromagnetic while the other is not, thereby allowing for electromagnetic readout capabilities.

The image read off the vehicle, the piece of equipment or the clothes of a soldier would be translated to a binary sequence, and interpreted according to a ciphersystem. The result would be a specified identification of the vehicle, or piece of equipment as being a friend, not a foe, and exactly which unit it belongs to.

The readout mixture sheets can be fitted on the battle items anew before a given encounter to frustrate any enemy attempt to full the readers.

The utility of this degreed-mixture identification is limited to line of sight, but then again, that is when the identification of vehicles, equipment and people is of the greatest import. The encoding can be placed on the battle items with great redundancy so that when part is damaged, the readout and identification can still be done.

3.3. Gate Switching Level

We can categorize mix-valve solution based on the sophistication and complexity of the gate switching mechanism.

Some options:
stationary solution
rotational disk solution
individual hole control

3.3.1. Stationary Solution

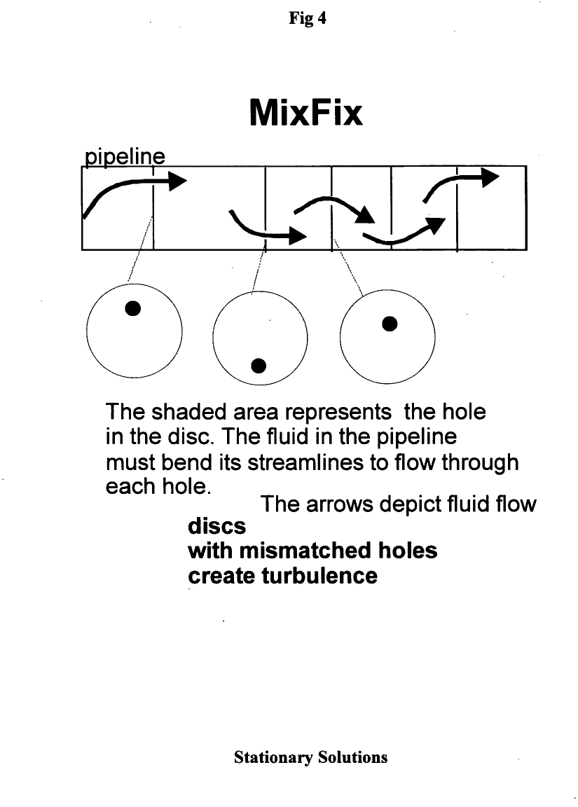

In this mode the hole that allows flow of fluid is stationary, fixed. In other words the mixing sequence is comprised of one hole hl which remains open for the entire period of time T. On its face this simple solution undermines the fundamental idea of the fluid acquiring different vectors of momentum. Albeit the stationary opening could serve as an element in a series of such units where the position of the stationary holes is off each other, thus forcing a bend in the flow lines, and achieving a degree of mixing. The advantage of this simple solution is that it has no moving parts, and is low maintenance. See FIG. 4 “Stationary Solution”

3.3.2. Rotational Disk Solution

The idea here is that a perforated disk rotates over a stationary surface (usually a similar size disk) which is also cut with holes. As the rotating disk turns, there are different zones on the stationary surface that become open for flow. These sections close back as the rotating disk keeps rotating while another set of holes opens up. The size of the holes in both the rotational disk and the stationary surface as well as the rotational speed determine the mixing sequence.

We discuss:
The openings layout
The opening switching mechanism
The assembly layout
Design Considerations

3.3.2.1. The Opening Layout

The openings will be designed as holes of particular shapes strategically placed on a disc which is placed in the way of the flowing fluid. Every state of the Mix-Valve would be characterized by defining for each of the openings (holes) their open/closed status. That status can be defined either in terms of open/close (the binary option) or in terms of an open-closed continuum ranging from 0%-open to 100% open.

If the disc comes with h physical holes it would have 2^{h} possible flow states, if one considers just the binary option, or theoretically infinity of states, if one considers the continuum option.

The total open area (the sum of the flow area from all the holes), on average, should be designed to fit the desired flow rate of the equipped line.

3.3.2.2. The Switching Mechanism

The stationary disc drilled with the flow holes (“holes”) would be fitted with a concentric rotating disc abreast to its surface. The rotating disc would be drilled with matching holes such that when it rotates on its axis against the abreast stationary disc, its rotating holes move over the stationary holes of the stationary disc, and at any instance create an open/closed status (defined either in a binary way, or in a continuum.).

The size, shape, placement of the holes of the rotating disc vs. those of the stationary disc, together with the rotating speed, and the pressure drop across the discs would determine the dynamics of open/close switching regimen.

We distinguish between a regular and irregular construction.

In a regular layout the holes are of simple shape, usually circular, and in an irregular layout the holes are complicated and placed in a ‘chaotic’ manner both on the stationary surface and the rotating disc.

3.3.2.2.1. Regular Disc Design

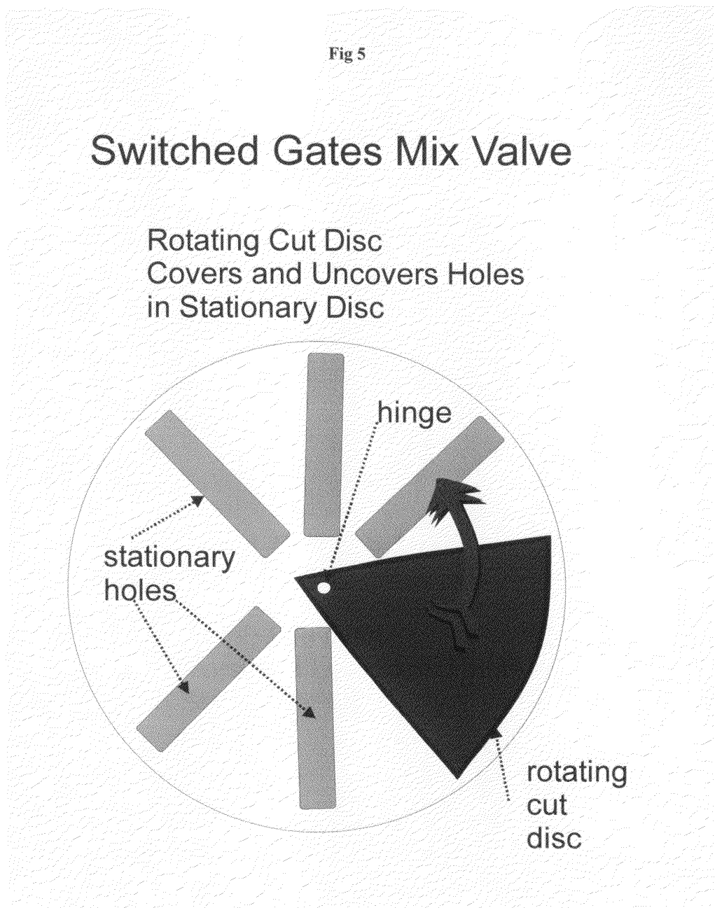

Regular disc design may feature a partial disc which may have no holes in it but when it rotates it periodically covers the existing holes on the stationary surface thereby creating the mixing sequence. Another option is a full disc divided to angular sections, each of which has holes corresponding to holes placed on a stationary disc of equal size (angular regularity). See FIG. 5: “Switched Gates Mixed Valve”

3.3.2.2.1.1. Angular Regularity Design

A regular angular disc design would feature several rows of holes, each row features holes that are placed from close to the center to close to the outer boundaries of the disc. The rotation would be designed so as to switch for each row the opened hole by order. So if we start with a given row with the first hole (closest to the center), then the next state of rotation would close that hole, and open the next. The third state of rotation would close the second hole, and open the third, and so on until the last hole in the row, and then the process would repeat with the first hole in each row. The rows would be phase-shifted, so that when a given row shows the first hole open, the next row shows its second hole open, and the row next to it shows the third hole open, and so forth. If the number of rows is kept equal to the number of holes in a row, there would be enough rows so that at any state of rotation each row would show open a different hole.

The shown stationary disc features four rows, each with four holes, all shaped like an angular trapezoid, or a polar element (two arcs and to radii). Each section occupies 360/4=90 degrees, and since this disc is designed for the regulatory valve option, the angular opening of each hole is A=360/(2*4)=45 degrees. This way, when the matching rotating disk is rotating over it, there are four states (within a full 360 degrees rotation) where there is no flow at all (no hole is open).

The holes are shown in shades.

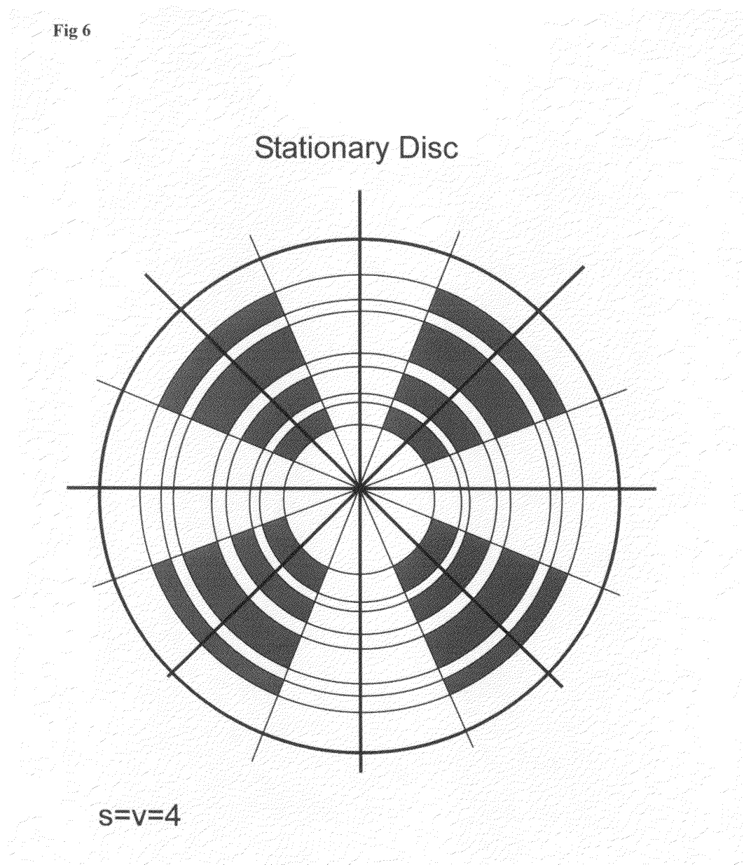

This rotating disc fits the previously shown stationary disc. In the first row, the first hole is carved out (drilled), [shown in shades]. In the second row, the 2^{nd} hole is carved out, in the third row the third hole is carved out, and in the fourth row the 4^{th} hole is carved out. Thus, when the rotating disc is rotating around the stationary disc it creates a sequence where each row in turn shows open a different hole, and for each row the holes are opened in sequence, creating a persistent turbulence in the incoming mixture. The rotating disc may be stationed at 22.5 degrees of the stationary disc, and thereby admit no hole—no flow. See FIG. 6,7 Stationary and Rotating Discs.

3.3.2.3. The Assembly Layout

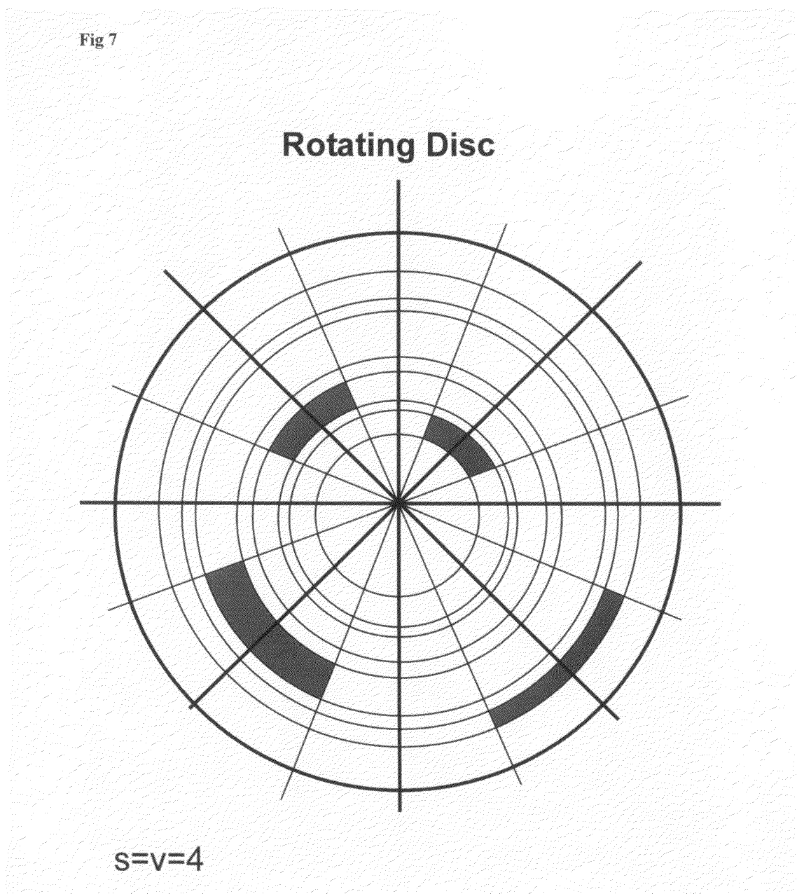

The industrial size Mix-Valve would be assembled as a flanged apparatus to be placed within a line of flow. It will fit for a large variety of pipe size and flow rates, and several sizes would cover the whole practical range of flow, viscosity, mixing and flow-regulatory requirement. See FIG. 8, “Mixer Valve Assembly”

The apparatus would be fitted with a vertical motor to rotate the rotating disc.

The Mix-Valve might operate as a valve-only, as a mixer-only, or as combination thereto. And hence its versatility.

The rotating motor could be a constant speed type (in the simplest case), a pre-set speed (in the intermediary case), and a instantly-variable speed, (position-sensitive)—in the most advanced case.

The Mix-Valve can be hooked in series along the lines so two or more assemblies insure high quality mixing.

3.3.2.4. Valve Design Considerations

We distinguish between the three options of valve requirements:
the no-value requirement
the on/off valve
the regulatory valve

In the no-valve mode the rotating disc would not offer a state in which there is no flow. This would allow the lion share of the stationary disc space to be drilled, (or say, carved) with holes, which in turn would allow for a smaller disc to serve a given requirement of flow rate, under the same pressure conditions. Each hole would experience a gradual opening and closing, which would translate into a constant shifting in the streamlines—mixing! The on-off option would feature small angular size for the holes so that each hole would be open and closed immediately, and the flow would alternate between max flow to zero flow. The regulatory valve option would feature holes with angular opening half the size of the no-valve mode to allow for gradual opening and closing together with the option of no-flow.

3.3.2.4.1. The No-Valve Requirement

In this mode, there is no need for a no-flow state (valve closed). Thus at all states of rotation the rotating disc would allow a certain amount of flow. The mixing would take place by a switch of the flow rate from some holes to the others.

This mode can be implemented with wide holes that would allow for a gradual opening and a gradual closing of each hole.

Accordingly we may design the stationary disc to feature holes in most of its area, and the rotating disc would open and close each of these wide holes according to its momentary speed of rotation.

3.3.2.4.1.1. The No-Valve Stationary Disc Design

Let there be h holes on the stationary disc.

Let us divide the disk to s angular sectors, each of angel 360/s degrees.

For each sector we would define the guiding radius as the radius drawn at the center of the sector, so that it marks a 360/2 s degrees angle between it and each of the boundary radii of the sector.

Let us mark v points on the guiding radius of each sector. the v points would be equally spaced so that the fixed distance d will be marked between them and between the first one (closest to the center) and the center, and also the distance marked between the last point (the furthest from the center) and the outer boundary of the disc.

There are v+1 such distances, hence:

d=r/(v+1)

where r is the radius of the stationary disc.

There are vs. points all together. Each of these points would serve as a center of a hole. Since there are h holes we can write:

vs.=h

We would further impose: v=s

Thus: h=s²=v²

3.3.2.4.1.1.1. The Shape of the No-Valve Holes

Because we have no requirement for a no-flow state, the holes may be wide and cover most of the disc. Accordingly the disc would form an angular trapezoid, or say a element of the surface in as defined in polar coordinates. Namely each hole would be defined by two concentric arcs connected with two straight lines, each of which forms a portion of a radius of the disk.

The distance between the arcs for all holes would be g, and the angle for each hole would be A.

A=(360/s)−2e

where e is a small angel specified such that the angel of 2e between two adjacent holes would provide sufficient disc material to insure structural integrity for the stationary disc. We also specify:

g=(r/v)−2f

where f is a small distance, to insure that two successive holes that would be distanced 2f from each other would provide sufficient disc material to insure structural integrity for the stationary disc.

The result is a disc with a majority of hole area. Only vertical strips of width 2f and concentric strips of width 2e angle would be left undrilled.

3.3.2.4.1.2. The No-Valve Rotating Disc Design

The rotating disc would first be marked by the same h holes as the stationary one. Same location, same size.

Let us mark the sectors as 1, 2, . . . s, and count the holes in each sector from 1 to v=s, when 1 is the hole closest to the center of the disc, and the v-hole is the furthest.

This counting would define the address or say the identity of each hole as Hᵢⱼ, meaning the j-hole in sector i.

Out of the h marked hole, the actual drilled holes in the disc would be as follows: drill all holes identified as: Hₖₖ, where k=1, 2, . . . s

In other words in sector 1 drill hole 1 In sector 2 drill hole 2 in sector 3 drill hole 3, . . . in sector s drill hole s.

We shall designate the undrilled holes, (all the holes identified as Hᵢⱼ where i<>j) as dummy holes.

3.3.2.4.1.3. Rotation Dynamics for No-Valve Option

Let us begin with the state where the two discs are placed on top of the other such that each Hᵢⱼ hole on the stationary disc is placed exactly below the same hole in the rotating disc.

In that state there are s holes through which the flow can transpire. These are holes Hₖₖ where k=1, 2, . . . s.

As the rotating disc starts to rotate the Hₖₖ holes gradually close and a new set of s holes gradually open. This gradual change continues until the original set of s open holes are completely shut, and another set of s holes opens.

These are the Hᵢⱼ holes where j=i−1 where i−1 for i=1 is defined as “s” (modular arithmetic).

When the disc continues to rotate the second set of holes gradually closes down, and a third set opens up (also gradually). Eventually the rotation reaches a state where the second group of holes are fully closed the third set is fully open. These are holes defined as:

Hᵢⱼ where j=i−2, where again the counting is done according to modular arithmetic: hole −1 is hole s, hole −2 is (s−1), hole −3 is (s−2), and hole s−k is (s−k+1).

This process of gradual closing of one group of s holes and gradual opening of the next group of s holes would continue s times until it repeats itself and the rotating disc is again at its starting position.

3.3.2.4.2. On/Off Valve Design

The overall considerations for the stationary disc are the same as for the no-valve option only that the angle A of the polar element would be narrower. Or say, the value of e would be large.

The holes on the rotating disc would be marked and carved to fit those on the stationary disc, and otherwise the design principles would follow the ones iterated in the no-valve mode.

3.3.2.4.3. The Regulatory Valve Design

The overall considerations for the stationary disc are the same as for the no-valve option only that the value of e=(360/4 s). This would mean that:

A=(360/2s)

The holes on the rotating disc would be marked and carved to fit those on the stationary disc, and otherwise the design principles would follow the ones iterated in the no-valve mode.

3.3.2.5. Construction

The MVA construction follows standard practices. It would fit into the host line through sealed flanges. The shaft of the motor would be fitted with no leakage option to the top of the assembly, and the two discs may be constructed from low-friction material, that would have the strength to withstand the pressure drop across them. In some cases the discs may be lubricated to reduce friction. The assembly itself may be cast iron or bolted or riveted from two halves, the upper and the lower one.

3.3.3. Individual Hole Control

In this design every hole is individually controlled as to its open or closed state.

We discuss:
control mechanism
gate design

3.3.3.1. Gate Design

### Options:

sliding door
perpendicular valve
contraction/expansion

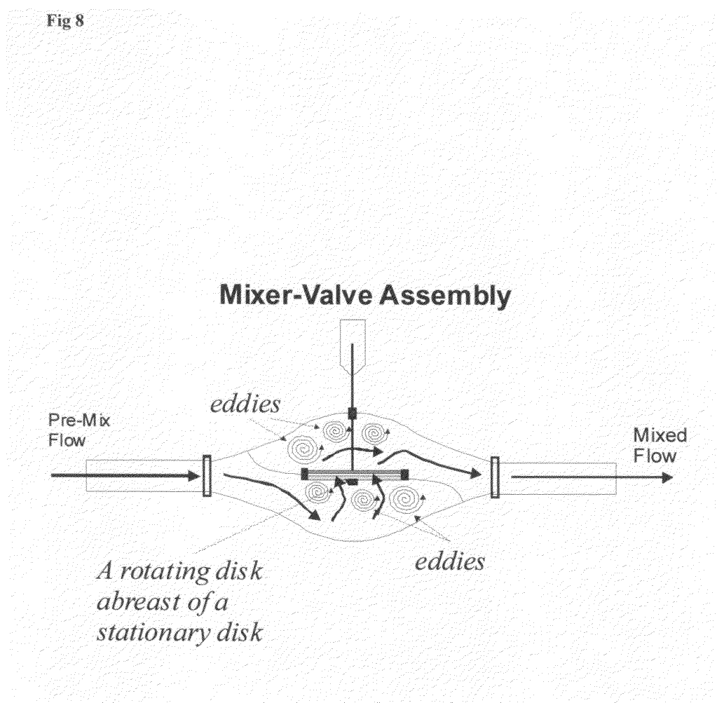

The sliding door design features a hole cover hinged on one point, and rotating around it to open and close the hole. The movement of the door is generally achieved electronically. See FIG. 9 “Switched Gates Mix-Valve”

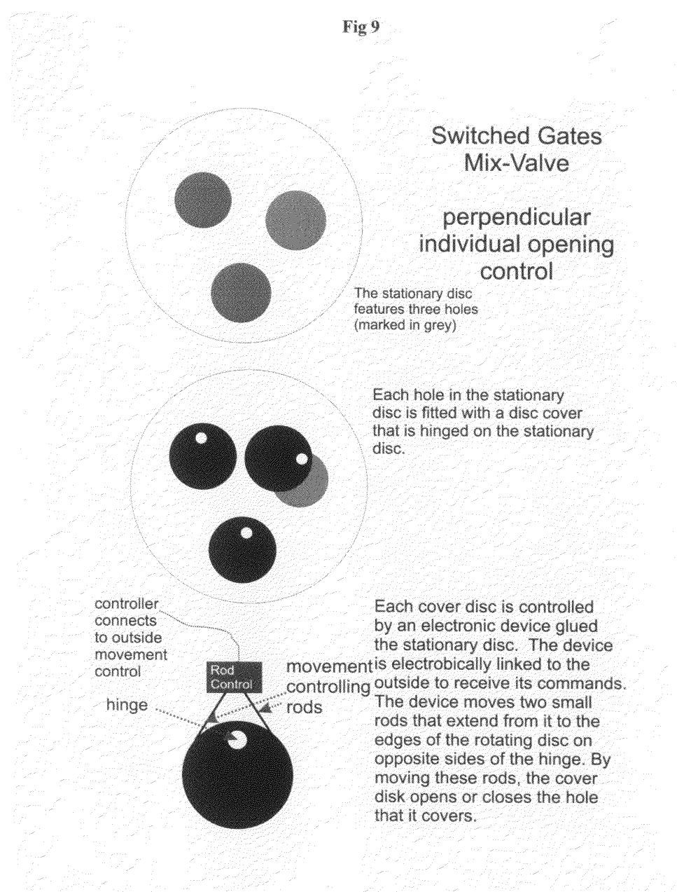

The perpendicular valve option calls for a valve that moves perpendicular to the surface with the hole. Move one way would close the hole, and move the opposite way would open it. See FIG. 10 “Individual Opening Control”

The contraction/expansion option calls for the neck, the orifice of the hole to contract (and close the opening), or to expand and enable the opening. These contraction/expansion options may happen as a response to some chemical force.

3.3.3.2. Gate Control Mechanism

### Options:

1. mechanical
2. electromechanical
3. chemical

3.4. Viscosity Based Classification

The Mix-Valve will work with a large variety of viscosity. It would be applicable for ideal gases, and also for Theological flow. Of course, the amount of energy needed for the mixing will vary.

3.5. Configuration

We distinguish between a single mix-valve unit, placed in the line of flow, and a configuration of several units acting in combination. Such units can be configured in series, in parallel, or a combination thereto.

The parallel combination would allow for small size flow cross sections to accommodate a large overall flow rate, by simply dividing that flow rates into smaller, more restricted pipelines. This might be important in cases where the mix-valve units come at a fixed pre-manufactured size, or where the operation of the unit is size dependent.

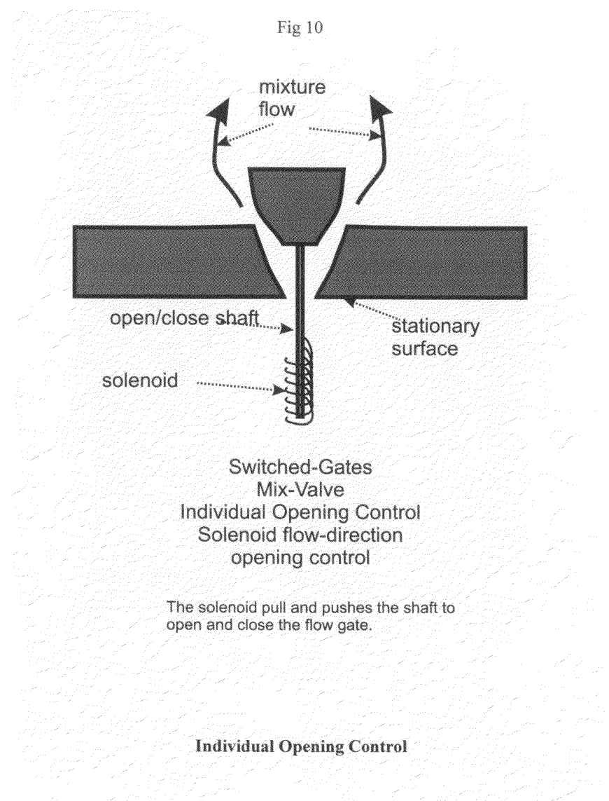

A series of units can be applied in order to perfect the mixture, or to place separators, or readers between successive mix-valve units. See FIG. 11 “Mix-Based Encoding”

Mix-Valve: Used to spot mix an additive into a plastic or other high viscosity bulk. By slicing the rod later one can visibly or instrumentally read the binary message.

### Shapeless Alphabet (Entropic)

Abstract—English letters and bar-codes are shapely—carry their data by the shape of their symbols. Alas, in the real world shapes are easily distorted, and resist readability. We developed an alphabet which does not rely on shapes to carry its information. Instead we rely on superficial qualities that are humanly recognizable, computer friendly, and most importantly, very resistant to smears, stains, surface deformation, bad reading angle, writing difficulties and such like. We consider two distinct materials one to be called “paper” (p), and the other called “ink” (i). Given any surface, S, ink and paper can be present there at a ratio i/p representing the respective area covered by each, and they can also be arranged at different mixing degrees. Both attributes will be used to encode a message. We also describe a device used to achieve a desired mixing degree to facilitate easy spraying of such shapeless (entropic) message.

Keywords: alphabet, identification technology, labeling, markers, message entropy, symbols technology.

### 1. The Nature and the Advantage of Entropic Alphabet.

All human readable alphabets, including the most popular languages are comprised of arbitrary signs and marks. These marks have intrinsic shortcomings: they are vulnerable to minute changes in ink stains (read error); they must be read from a certain fixed direction. From a different direction they may be read as different letters (e.g. “6” vs. “9”). They must be placed in distance from each other, because the combined sign of two touching letters may be quite confusing. They are also sensitive to the curvature of the written surface, if it is not flat, it may project a different letter. Other shortcomings are a fixed letters size, and deformation sensitivity.

On a purely theoretical basis it is advantageous to migrate from highly arbitrary symbols to less arbitrary ones, (to more “natural” ones), that can be readily understood, and grasped as distinct. Such symbols might be surface based in the sense that a given surface is read as a whole to discern the letter of that natural alphabet. Surface based lettering will remove the deformation sensitivity experienced by regular letters. They might also overcome some of the other shortcomings inherent in the traditional graphic alphabets.

The surface based letter indication would free the shape of the letter for further communication. Thus if the letter “A” is read through the ink patterns on a given surface, then the shape of that surface may be reserved to communicate more information.

Surface based lettering then, may be shape free. The information that identifies a certain surface as a given letter should be the same regardless of the shape of that surface section.

We are now reduced to the following question: given two distinct components to be called “paper” and “ink”—how to arrange them such that a given surface marked with both would indicate a given letter from an alphabet. The reading should be the same regardless of the shape of the surface. The natural two properties of any surface marked with two components (we can call them two colors) is the proportion of each color, and their superficial distribution.

Superficial ratio is clearly defined. For any designated surface, S, one can measure the area p covered by the color “paper”, and the area “i” covered by the color “ink”. The ratio (i/p) may indicate a given letter. Clearly the i/p ratio works for various shapes of the surface S.

One could map l letters to the range of values of (i/p). The smaller the number 1, the greater the error resistance to accurately reading a marked letter.

When it comes to distribution, any specific shape will suffer from the same shortcomings common to all the nominal graphic alphabets. A non-specific metric is called for. Such may be found in the notion of mixing degree. Ink and paper may be (1) thoroughly mixed, (2) they may be totally unmixed, separate, or (3) they may be at any mixing degree in between. It is important to note that mixing degree is an independent attribute from the i/p ratio. Generally various i/p ratios can be thoroughly mixed or loosely mixed.

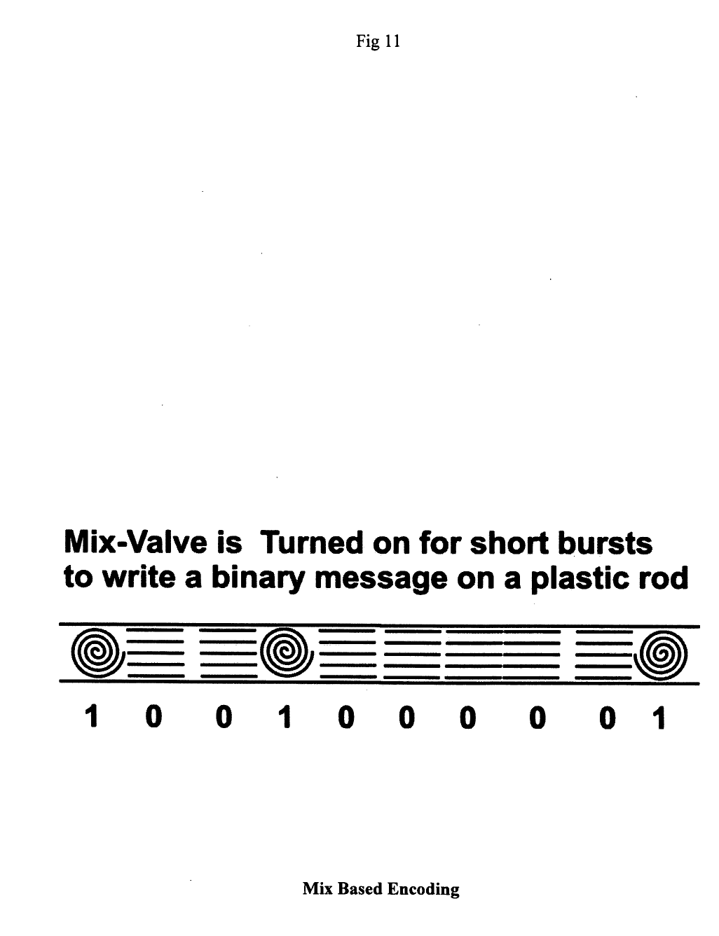

FIG. 12 illustrates letter distinction by mixing degree.

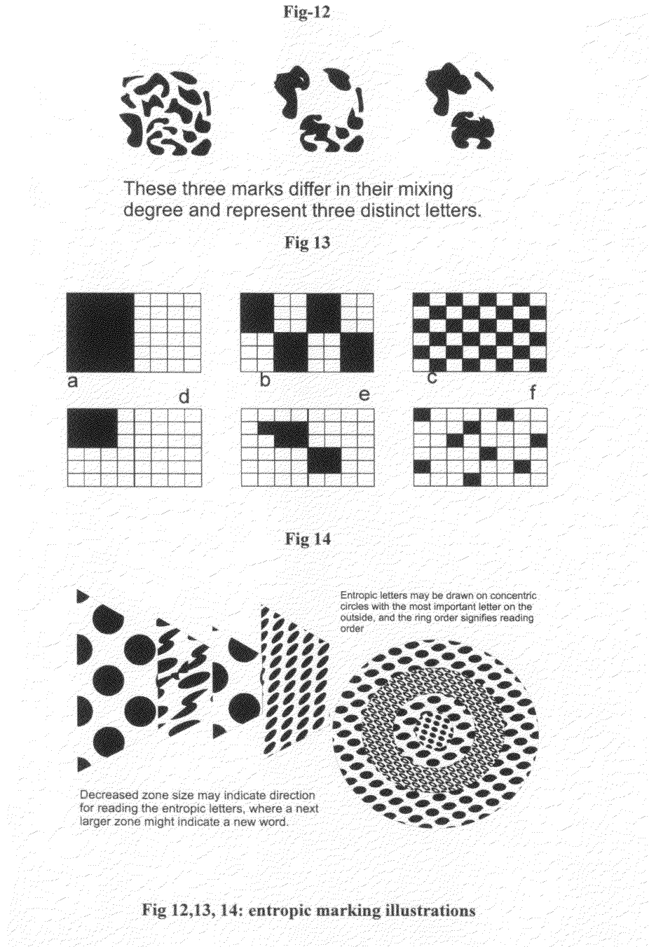

Examine FIG. 13:

Cases (a,b,c) all share the same i/p=0.5, but differ in their distribution measure of ink over paper. Cases (d,e,f) share the same i/p=9/48 but differ in their ink distribution level. These 6 cases can pass for 6 different letters.

Mixing degree, like the i/p ratio, is independent of the size or shape of the surface section S. Mixing is closely associated with Shannon definition of entropy, and hence an alphabet that is based on mixing degree is aptly called ‘entropic’. If, for instance, the (i/p) ratio would be divided into 10 distinct zones, and similarly for the mixing degree then any given surface S would be mapped into a field of 100 letters, symbols, or values. Below we offer a mathematical definition of mixing degree—the entropic value of a mixture.

One important attribute of a mixing-degree letter designation is that it is inherently many-to-one. Namely: there are many specific distributions of ink over paper that would qualify under the same mixing degree. This in turn gives rise to subliminal messaging or steganography, using the specific choice of distribution-compliant ink spattering to communicate an underlying message.

In the extreme case one would use a binary coding, for both i/p ratio, and for the entropy (mixing degree). Namely for i/p ratio one would select i/p=0.25 and i/p=0.75 as two values which have a large enough gap between them (so that the i/p ratio will be readable by the naked eye), and yet i/p will not be too close to 0 or infinity, since these limits reduce the many-to-one quality of the entropic letter. For mixing degree the binary choice would be between “unmixed, or almost unmixed” to “thoroughly mixed”. This would reduce each surface section to carry four letters only.

Entropic alphabet shows a distinct advantage when it comes to combining symbols to words or large numbers.

First any two entropic letters may be put adjacent to each other, without any confusion, and they can be of varying size—again, without any confusion. The reader would simply read one mixing zone, then the other. This situation denies one the ability to write words with repetitive letters since, for example, the word “AAB” would read the same as “AB”. But this handicap can be easily overcome by using some (n−1) letters alphabet to express any expression, and then adding an n-th letter to break up any apparent repetition. In the example above one would write “AAB as “ACAB” to distinguish it from “AB”. And this added letter “C” would be ignored when the word is interpreted from its entropic expression.

The question arises with respect to the order of reading. One could designate an arbitrary direction on the surface and reading would proceed along that axis, but that would undermine the entropic alphabet invulnerability to changes in reading directions.

Some geometric solutions are shown below. (FIG. 12,13,14):

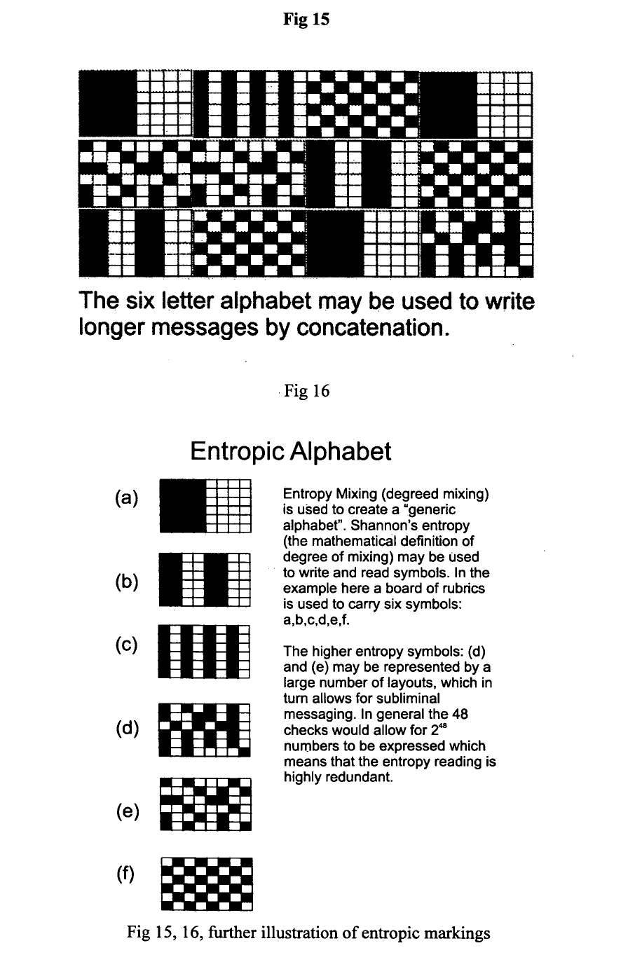

Entropic alphabet is in principle less arbitrary than all the common humanly readable alphabets, and this attribute on its own opens some interesting avenues for effective communications all around. (A teaser: how to communicate to extraterrestrials, using a least arbitrary alphabet?). FIG. 15, 16, 17, 18 illustrate these aspects.

### 2. Robust Definition of Mixing Degree

We first define complete mixing, then a degreed option.

COMPLETE MIXING: If a component x of quantity X is mixed with a component y of quantity Y, within some reference space, then a complete mix will be a situation where for an arbitrary volume V in the reference space there will hold, either:

Xv→0; and Yv→0: (1)

Xv/Yv→X/Y (2)

where Xv and Yv are the quantities of x and y in volume V.

If the above holds throughout the reference space for all V≧δ, where δ is the smallest volume where it is possible to have: Xv=(X/Y)Yv≠0, then the mixture is regarded as complete, or “perfect”.

This definition can readily be extended to an arbitrary number of mixed components.

PARTIAL, OR DEGREED MIXING: There are many ways to define partial, or degreed mixing. One would eventually pick the most advantageous. Here below is one such definition. We focus on a portion U of the reference space, such that condition (i.) of the complete mixing is not observed anywhere in it. In other words, U is the portion of space where at least one of the two components (x,y) is present. We divide U to t units of δ size each. The division may call for the δ-size volumes to be mutually exclusive (every point in U is part of one, and only one δ-size volume), or otherwise (as long as it is well defined). Let m be the number of δ volumes where condition (ii) of the complete mixing is satisfied, then M=m/t will be regarded as the mixing degree with respect to U, and the U partition into t volumes of size δ. Clearly: 0≦M≦1.0. One could use the same definition with respect to a different size volume v>δ. In such a case one may want to use tolerance measure Δ<1.0, and count the number of v size volumes, m, where:

$$( 1 - Δ ) \frac{X}{Y} \leq \frac{Xv}{Yv} \leq ( 1 + Δ ) \frac{X}{Y} \qquad ( 3 )$$

and then define the mixing degree M(v, Δ)=m/t.

ENTROPIC WORDS: A word is a sequence of letters from the same alphabet. We may distinguish between equalized words, and ranked words. The former are words where the letters are all of equal importance, or nearly so. The latter are words where the first letter is the most important one, the second a bit less so, and so on. such is the case with numbers using the venerated positional order. Ranked words can be written as a sequence where the more important letter is written on a bigger surface than the less important one (to reduce chance of misreading the more important letter).

In both cases the letters can be placed adjacent to each other. The shapes of the letters can be used to indicate direction of reading, as well as a break between words, to string sentences together.

### 3. ENTROPIC WRITING

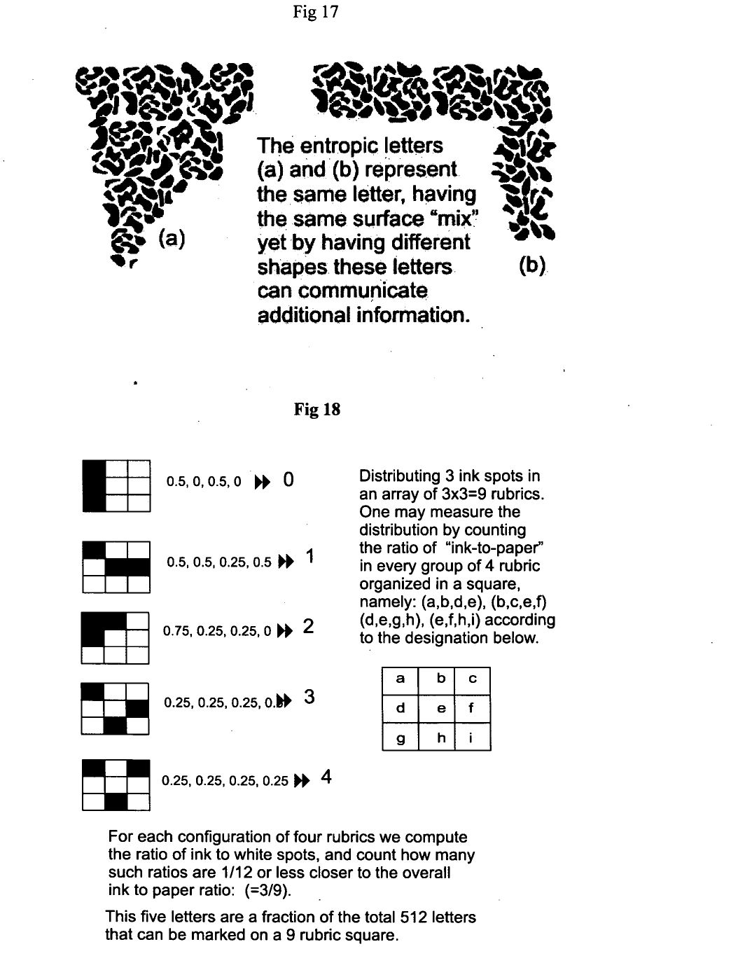

The code writing would be effected through an automated painting machine. Two paints, one called “paper” the other called “ink” would be fed into the “entropic writer”. The two inflows will be fed into a mix-valve contraption. The mix-valve is a device that can deliver accurate degree of mixing. The mix-valve will operate under the control of a computer to which one would type in the code (the word, the phrase) to be painted. Based on this code, or word, the computer would compute the commands to the mix-valve contraption. Mixing degree will rise and fall according to the written message. The mixed paper and ink will be jet painted onto the painted surface. The entire apparatus would be sliding on rails with a speed controlled by the same computer. The result would be a horizontal smear of paint where the mixing degree changes according to the punched in words. The same words would repeat for the entire stretch of the painted surface. The surface itself does not have to be flat or even. The painting would work through dents, protrusions, and even some holes. Repainting is straight forward. The old code will be painted by a paper-only paint, and then repainted by another ink-paper mix to write the new message. See FIG. 19 “Hand Held Entropic Painter”

### 4. CODE READING

Reading the identification tags off a distant vehicle may be done manually, using, say a binocular, and writing down the letters, as one would identify a Morse code. Entropic reading could be taken place automatically through a tele-lens that would capture a painted image, and then read the image and interpret the mixing degree to discern its letters. The result could be fed to the human operator of that automatic tele-lens. The automatic image taking and interpretation of the entropic message can be handled potentially by a hand-held device aimed at the painted surface in question (so used by infantry and special forces), or it may be embedded in a more elaborate system and be part of the larger management task.

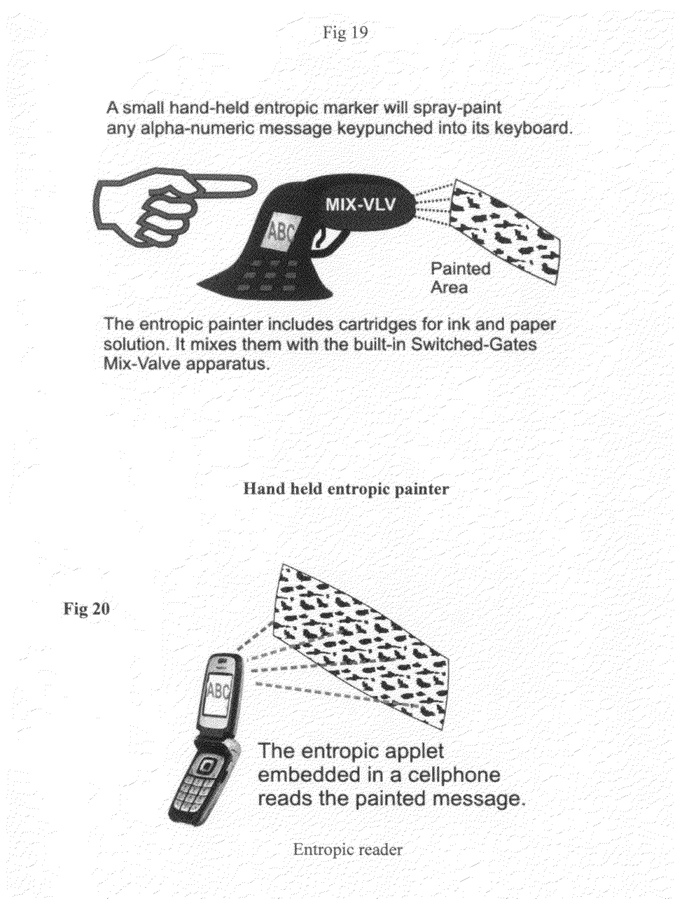

The entropic message can be designed to be read using other than normal light. Options are: infra red, and electromagnetic beams. The former can be achieved by using ink and paper with distinct thermal properties, so that the IR sensors would be able to discern the difference. The latter can be achieved by using ferromagnetic materials. See FIG. 20 Hand Held Entropic Reader”

### 5. ENTROPIC MARKING IN SHIPPING AND CONSTRUCTION

Today in these industries one has to undertake a laborious process for marking crates, lumber, big boxes, and large pieces of equipment. Such marking is commonly accomplished via a plate with carved out letters which is painted over to leave the lettering marks on the crates and other objects. Entropic alphabet would allow for much easier tagging.

We envision a tagging worker walking around with a normal size paint sprayer which is essentially an entropic painter. He punches in the tagged letters and numerals (using an attached keyboard), and then he simply aims the sprayer onto the wall and moves it about while pressing the spray trigger. The embedded computer sucks in proper measures of ink and paper solution, mixes them according to the tagged letters and numerals, and the sprayed area then captures the desired encoding. This can be repeated on different swaths of areas on the crate, and that's it. If the same tag is needed on another crate, it is simply repeated: this second item is sprayed in the same fashion. One could also allow for the computer to atomically increment a count figure so that each item sprayed will indicate a successive count. The worker does not have to touch the items, simply walk by them and spray them with the entropic painter.

The entropic code can (although somewhat laboriously) be read by the naked human eye). Albeit, the common way will be to use one's cell phone, aim its camera to the entropic tag, and push ‘read’ and the proper tag is immediately displayed on the cell phone screen. The cell phone applet will compute the entropic paint to its intended tag. A dedicated entropic reader might also be used.

This quick and easy marking is likely to be used in shipping yards, lumber yards, construction sites, and alike.

Imagine an unskilled worker walking around a construction site, a lumber yard, or a loading dock, quickly spraying an identification label on all items around. Remember that the software can automatically increment a count figure for inventory management. Entropic markings may in the future identify shipping containers, loaded crates, and leased heavy equipment, helping with tracking them from the air (helicopters), and from satellites! One may envision an easy store checkout. Shoppers simply load boxed items from the shelf to their cart, and as they do so an overhead entropic reader logs that item for that shopper. Compare this distant, reliable label-reading with the intimate proximity required by the competing technology of RFID. In other words entropic alphabet has the potential to do good in the field of construction, shopping, shipping, development and progress.

FIGS. 9, 10 illustrate industrial use of the entropic alphabet. FIG. 11 depicts an industrial marker of entropic messages.

### BIPSA Based Entropic Reading:

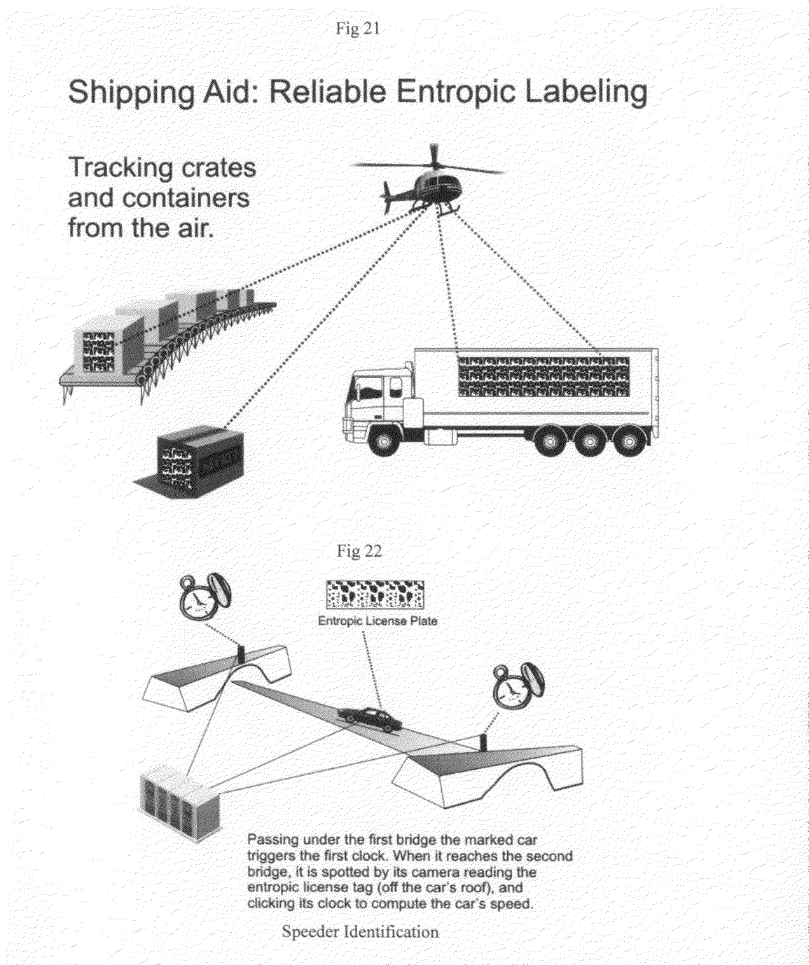

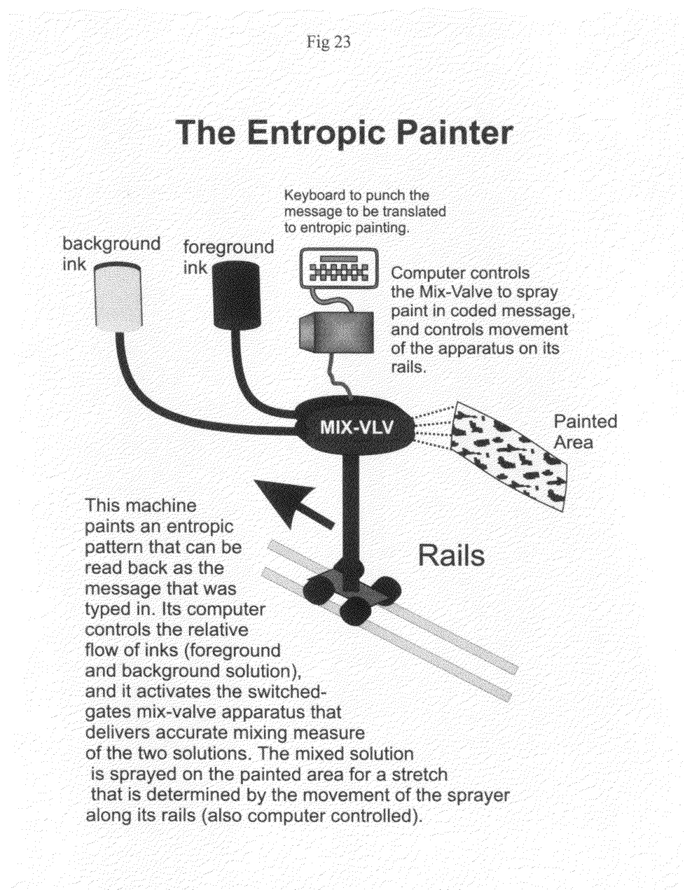

The BiPSA method captured in patent application Number 11790876 offers a quick and easy method to read and ascertain level of entropy of a painted mixture. Each pixel or zone of reading is surrounded by 8 pixels that can serve BiPSA dwarfs to estimate the color the central pixel. In case of two colors, for instance, if the eight surrounding pixels are all of the first color then the estimate for the color of the pixel will be the same color with confidence measure of 8. If n pixels will be of the first color and 8-n pixels of the other color than the majority count will be the BiPSA estimate and the gap between the counts will be the degree of confidence of that estimate. The estimate will then be compared to the actual color. A correct estimate will be accounted for by a positive increment to an accuracy count where the increment will be at the level of confidence. If the actual reading will be the opposite color then it would result in a decrement of the accuracy count where the decrement level will be the level of confidence of the estimate. The resulting accuracy count for the surface, or for any area will reflect the predictability (or entropy) of the area. This is a very fast and efficient entropy calculation. See FIGS. 21, 22.

### 6. CONCLUSIONS

Shapeless (Entropic) Alphabet offers a tagging system fit for various industrial applications. Entropic Alphabet messages can be easily marked on any surface, they are computer friendly, and humanly readable. They resist distortion, stains, dents, and can be marked ad-hoc or through pre-labeling. Entropic Alphabet tagging exhibits clear advantages over normal alphabet; as well as over bar-codes.

What is claimed is:

1. A method to effect mixing of two or more fluids such that the degree of mixing is accurately controlled, allowing the partially mixed output to be utilized for encoding, and other applications, and where the mixing is effected via an in-line contraption comprised of one stationary disc featuring certain holes and openings, and another rotating disc featuring matching holes and openings such that when the rotating disc rotates it creates “moving holes” in the cross-section of the flow pipe, such that the flow lines are broken, shifted, and in summary become turbulent in a degree controlled by the shape and size of the openings on the two discs, and the speed of rotation of the rotating disc; the rotating disk may be positioned to rest such that there is no congruence between the openings in the two discs, and hence the apparatus functions as a closed valve, or the rotating disc may be positioned such that a fixed hole is present and in that case the contraption operates as a valve in the open position.
(1.1) The method in (1) used to effect efficient in-line mixing in lieu of a regular blade mixer.
(1.2) The method in (1) used to encode a viscous material through sections of various degrees of mixing of two or more components.
(1.3) The method in (1) used to create decorative mixings of incompatible paints.
(1.4) The method in (1) applied to write messages using entropic alphabet as defined in claim (2), and implemented either via (i) a hand held sprayer where the encoded message is computer processed to instructions for the rotating disc to move at certain speeds over time to spray a mixture that encodes a desired message; or implemented via (ii) an industrial size entropic writer which too is computer controlled to produce a sequence of output that encodes a desired message.

2. a method to encode messages via an alphabet based on the degree of mixing of two or more distinct components where the ratio of the components together with their entropy (their mixing degree) will be used to encode various letters comprising a desired message.
(2.1) a method to read messages created by painting the mixed output of the contraption in (1) operated on the principles of the method in (2) by applying the BiPSA method presented in utility application 11790876 where the entropy of a mixture is determined by computing the degree of accuracy of predicting the component on each camera captured pixel based on the components of the neighboring pixels.
(2.2) a method to apply the mixing degree alphabet (entropic alphabet) to military purposes where assets like soldiers, vehicles, etc. will be marked with entropic camouflage, and embedded computers within machineguns and fire arms will be able to prevent friendly fire by recognizing the fired upon target as asset, not a threat.
(2.3) a method to apply the mixing degree alphabet (entropic alphabet) to industrial control where large boxes, items, and vehicles are painted with entropic messages which are subsequently read via helicopters or strategically placed stationary cameras, helping manage assets and inventory.
(2.4) a method to use the entropic alphabet to aid retail operation by using the many store cameras to track movements of boxes and other large items from the shelves to carts and to checkout counters.
